(19) United States
(12) Patent Application Publication
(10) Pub. No.: US 2017/0339999 A1
(43) Pub. Date: Nov. 30, 2017

(54) DEVICE AND METHOD FOR REMOVING COCONUT WATER AND MEAT

(71) Applicant: MONARCH MEDIA LLC., LAS VEGAS, NV (US)

(72) Inventor: VINCENT ZALDIVAR, LAS VEGAS, NV (US)

(21) Appl. No.: 15/682,336

(22) Filed: Aug. 21, 2017

Related U.S. Application Data
(62) Division of application No. 15/236,107, filed on Aug. 12, 2016.
Application No. 15/236,107 is a continuation-in-part of application No. 14/557,783, filed on Dec. 2, 2014.

(51) Int. Cl. A23N 5/03; A47J 43/06; A47J 43/26; A23N 1/00; A23L 2/04; A47J 43/044; A47J 19/02; B28D 1/04; A47J 43/07

(52) U.S. Cl. CPC A23N 5/03; B28D 1/041; A47J 43/06; A47J 43/26; A47J 43/0711; A23L 2/04; A47J 43/044; A47J 19/022; A23N 1/00; A47J 2043/04409

(57) ABSTRACT

A device for removing coconut water and meat from a coconut has a drill unit. A first attachment is removable coupled to the drill unit to drain the coconut water. A second attachment is removable coupled to the drill unit to open the coconut to remove the coconut meat.

### RELATED APPLICATIONS

This patent application is a Continuation-In-Part of U.S. patent application having a Ser. No. 14/557,783, and a filing date of Dec. 2, 2014 which claims the benefit of U.S. Provisional Application No. 61/916,361, filed Dec. 16, 2013, entitled “COCONUT WATER REMOVAL DEVICE AND METHOD THEREFOR” in the name of the same inventors, and which is incorporated herein by reference in its entirety.

### TECHNICAL FIELD

This disclosure relates generally to a fruit opening system, and more particularly to a system and method to open a coconut to access and drink the coconut water stored within the coconut and remove the coconut meat.

### BACKGROUND

Coconut water is a liquid that forms naturally inside the shell of a coconut. It is a common drink in many tropical countries and is becoming more popular in the United States as many companies are marketing it as a natural sports drink. Coconut water has fewer calories, less sodium, and more potassium than most sports drink. Ounce per ounce, most unflavored coconut water contains 5.45 calories, 1.3 grams sugar, 61 milligrams (mg) of potassium, and 5.45 mg of sodium compared to Gatorade®, which has 6.25 calories, 1.75 grams of sugar, 3.75 mg of potassium, and 13.75 mg of sodium.

Coconut water should not be confused with high-fat coconut milk or oil. Coconut water is a clear liquid in the fruit's center that is tapped from young, green coconuts.

Presently, there is no easy way to remove the coconut water from within the coconut. In general, most people try to find the soft “eye” of the coconut. The soft “eye” is a black spot located at the top of the coconut. Once the soft “eye” of the coconut is located, a person may use a metallic skewer such as a screwdriver to pierce the coconut. Alternatively, a nail and a hammer may be used to create the opening in the soft “eye”.

Once the soft “eye” has been pierced, the skewer may be pushed towards the interior of the coconut. The skewer may then be removed and the coconut water may be drained into a bowl or other container.

Unfortunately, the above method is not easy. Further, it does not allow one to easily drain the coconut water. Many times after removing the skewer and trying to drain the coconut water, the coconut water tends to hug the side of the coconut and spill never reaching the bowl.

Many individuals like to use fresh coconut for consumption. However, most of these individuals have no way and/or tool to crack open the coconut in order to access the coconut meat. Individuals have used hammers, butcher knives/meat cleavers and the like to open coconuts to access the coconut meat. However, use of the above mentioned devices could be dangerous. Further, even if the individual is successful in opening the coconut using the above mentioned devices, the coconut water may be spilled and possibly lost.

Therefore, it would be desirable to provide a system and method that overcomes the above.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a device for removing coconut water and meat from a coconut is disclosed. The device has a drill unit. A first attachment is removably coupled to the drill unit to drain the coconut water. A second attachment is removably coupled to the drill unit to open the coconut to remove the coconut meat.

In accordance with one aspect of the present application, a device for removing coconut water and meat from a coconut is disclosed. The device has a drill unit. The drill unit has a drive unit. A motor is used to rotate the drive unit. A connector is formed on a distal end of the drive unit. A first attachment is removably coupled to the drill unit to drain the coconut water. The first attachment has a tubular member. A connector is formed on a first end of the tubular member. A plurality of teeth extends down from a second end of the tubular member. A second attachment is removably coupled to the drill unit to open the coconut to remove the coconut meat. The second attachment has a cylindrical member. A connector is formed on a first end of the cylindrical member. A plurality of teeth extends down from a second end of the cylindrical member.

### BRIEF DESCRIPTION OF THE DRAWINGS

Embodiments of the disclosure will become more fully understood from the detailed description and the accompanying drawings, wherein:

FIG. 1 is a perspective view of the coconut water removal device;

FIG. 2 is a front view of the coconut water removal device;

FIG. 3 is a top view of the coconut water removal device;

FIG. 4 is a bottom view of the coconut water removal device

FIG. 5 is a side perspective view of the coconut water removal device with the lid on inserted into a coconut;

FIG. 6 is a front perspective view of the coconut water removal device with the lid off inserted into a coconut;

FIG. 7 is a perspective view of another embodiment of the coconut water removal device;

FIG. 8 is a first side view of the coconut water removal device of FIG. 7;

FIG. 9 is a back side view of the coconut water removal device of FIG. 7;

FIG. 10 is a second side view of the coconut water removal device of FIG. 7;

FIG. 11 is a front side view of the coconut water removal device of FIG. 7;

FIG. 12 is a perspective view of a coconut water and meat removal device;

FIG. 13 is a perspective view of the coconut water and meat removal device forming a drainage hole in a coconut; and

FIG. 14 is a perspective view of the coconut water and meat removal device forming an opening to remove coconut meat.

### DESCRIPTION OF THE DISCLOSURE

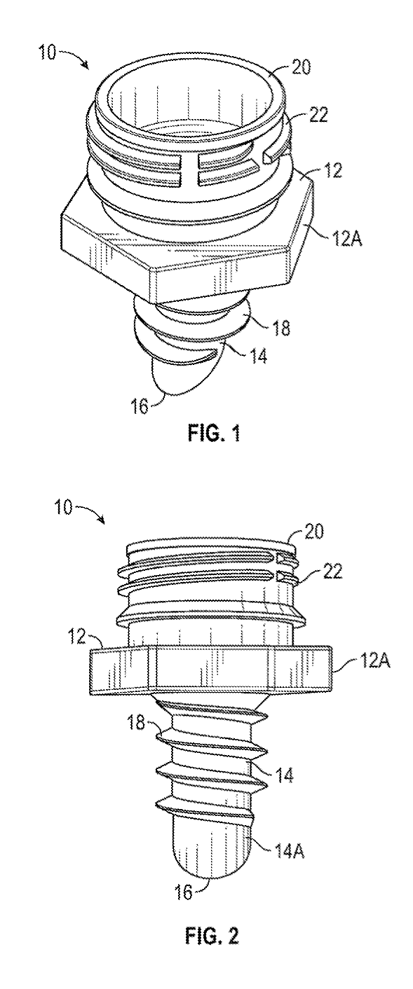

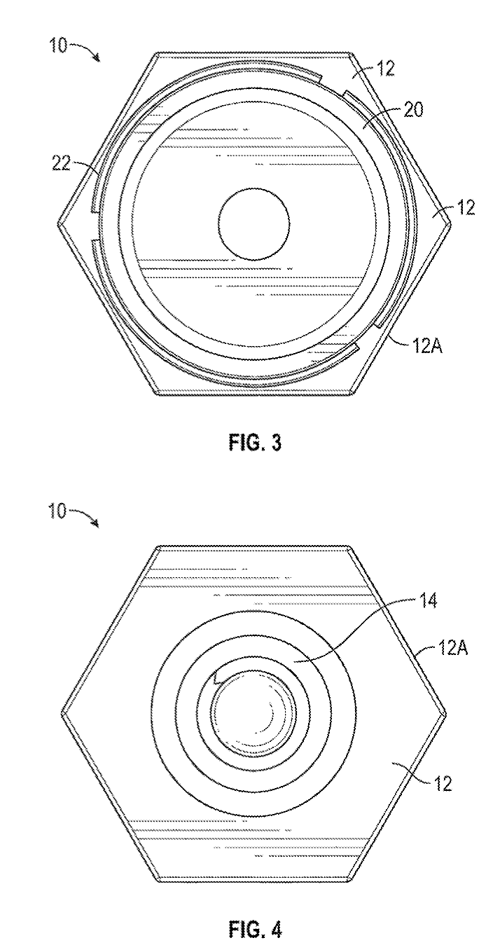

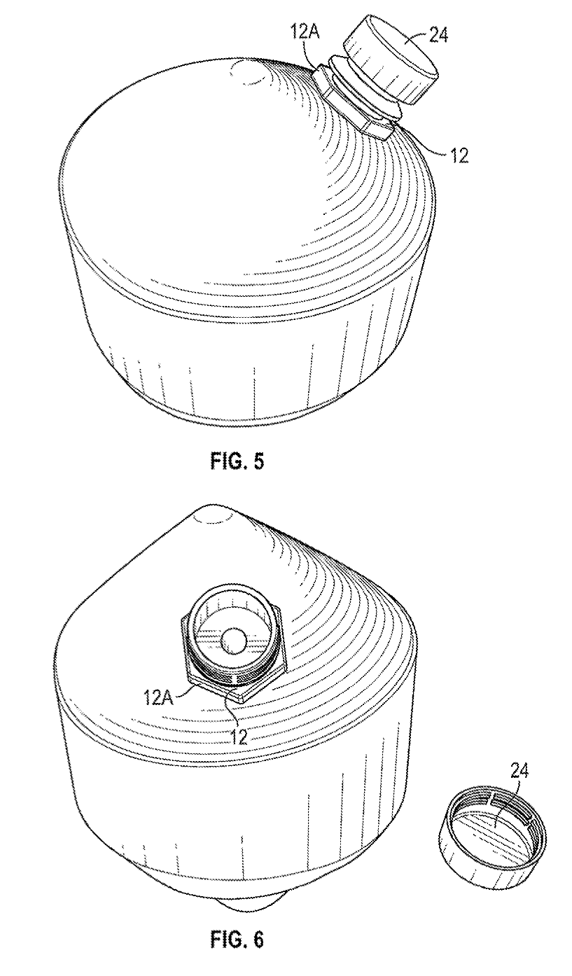

Referring to the FIGS. 1-6, one embodiment of a coconut water removal device 10 (hereinafter device 10) is shown. The device 10 may be inserted into a coconut 26 to drain the coconut water formed inside the coconut 25. The device 10 may be used to convert the coconut 26 into a drinking device with a resealable top that can be opened and closed at will.

The device 10 may have a base member 12. The base member 12 may have a plurality of flat surfaces 12A formed around an outer perimeter of the base member 12. The number of flat surfaces 12A may vary. The flat surfaces 12A may be arranged so that the base member 12 can be configured as a hardware nut.

A tubular member 14 may extend downward from a central area of the base member 12. A distal end 14A of the tubular member 14 may be cut at an angle to form a pointed edge 16. The pointed edge 16 may be configured to allow the device 10 to cut through the outer shell of the coconut and be inserted into the interior of the coconut. The tubular member 14 may have threading 18 formed around an exterior surface thereof. The threading 18 is a helical structure used to convert between rotational and linear movement or force.

A spout 20 may extend up from a top section of the base member 12. The spout 20 may be in fluid communication with the tubular member 14. Thus, a pathway may be formed from the spout 20, through the base member 12 and through the tubular member 14. Thus, the spout 20 may be used to pour out the coconut water from the interior of the coconut once the device 10 is inserted into the coconut. Ribbing 22 may be formed around an outer surface of the spout 20. The ribbing 22 may be used to secure a lid 24 or closure device to the spout 20.

In use, a user of the device 10 may push the pointed edge 16 of the device 10 into the soft “eye” of the coconut. While it is easier to insert the device 10 into the “eye”, it may be inserted into other areas of the coconut. A user may then use a wrench or similar tool to rotate the base member 12 thereby causing the threading 18 of the tubular member 14 to rotate into the coconut. The threading 18 can secure the device 10 to the coconut and further prevents leakage of the coconut water from the soft “eye” of the coconut where the device 10 was inserted. Once the device 10 is inserted and tightened, the user may pour the coconut water out via the spout 20 or use the device 10 to drink the coconut water directly from the coconut. The user may place the lid 24 on the device 10 and reseal the coconut if all the coconut water is not drunk.

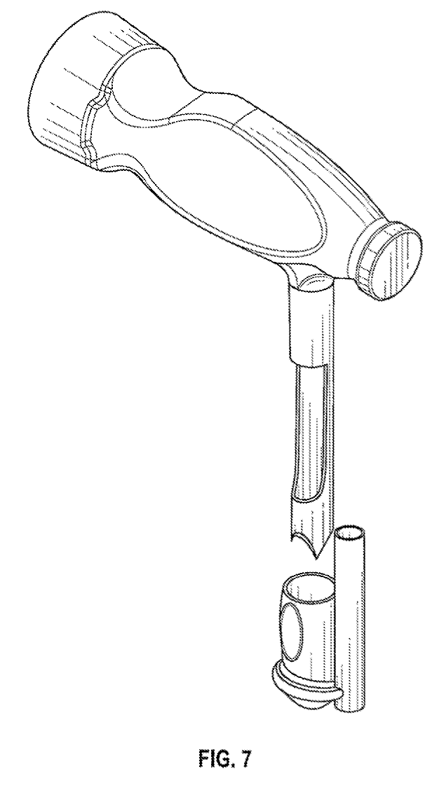

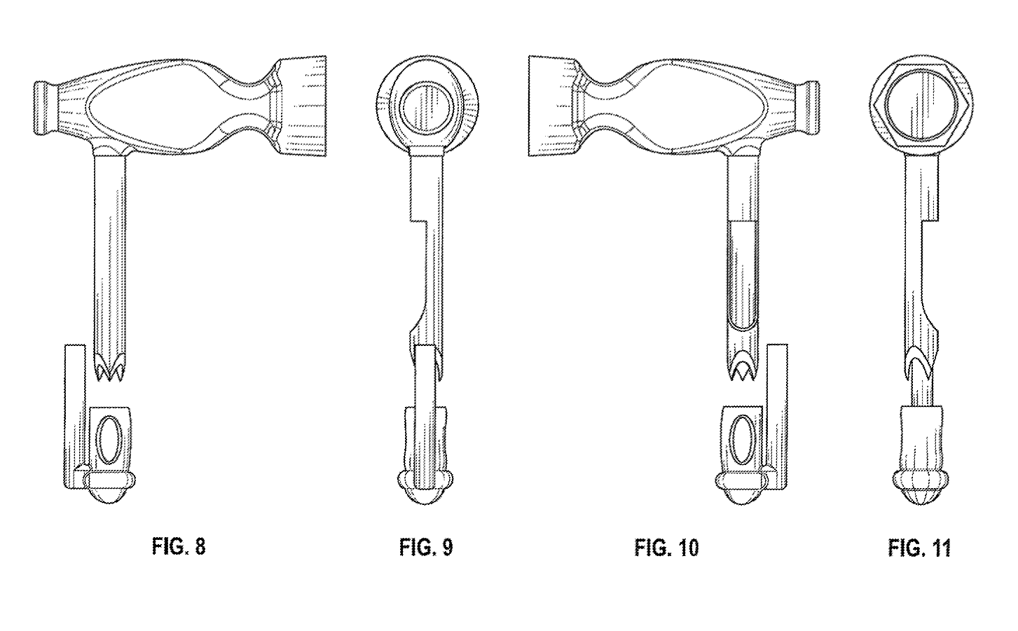

Referring to FIGS. 7-11, another embodiment of a coconut water removal device 10′ (hereinafter device 10′) is shown. The device 10′ has a handle member 30. The handle 30 may be used to grip the device 10′. In accordance with the embodiment shown in FIGS. 7-11, the handle 30 may have a curved section 30A. An indented area 30B may extend from the curved section 30A. The handle 30 may be configured to allows one to more comfortable grab the handle 30 when using the device 10′

The device may have a tubular member 42. A first end 42A of the tubular member 42 may extend down from a bottom section 40C of the handle 30. A second end 42B of the tubular member 42 may have a jagged configuration. The second end 42B may have a plurality of teeth 44 extending down from the second end 42B. The teeth 44 may be sharp to allow the tubular member 42 to cut and penetrate into a coconut as described below.

The tubular member 42 may have an opening 46 formed therein to expose an interior of the tubular member 42. The opening 46 may have a rounded/curved bottom section. The opening 46 may be used to remove any debris and/or items that may be stuck in the interior of the tubular member.

The device 10′ may have an end cap 48. The end cap 48 may be positioned over the second end 42B of the tubular member 42 when the device 10′ is not in use. The end cap 48 may be used to protect others from being hurt and/or cut by the second end 42B of the tubular member 42.

In the embodiment shown, the end cap 48 may have a tubular cap member 50. The tubular cap member 50 may be configured to fit snugly over the second end 42B of the tubular member 42. A rod member 52 may be attached to the tubular cap member 50. The rod member 52 may be dimensioned to fit within the tubular member 42.

In operation, the user may grip the device 10′ be grabbing the handle 30. The user may grip the handle 30 with a palm of the user's hand pressing against a top section of the handle 30 and the user's fingers wrapped around a bottom section of the handle 30. The user may press the second end 42B of the tubular member 42 into the soft “eye” of the coconut. The device 10′ may be inserted into other areas of the coconut without departing from the spirit and scope of the present application.

When the device 10′ has reached the interior of the coconut, the user may remove the device 10 from the coconut. A pathway may be formed within the coconut to allow the user to drain the coconut water from the coconut.

When the user removes the device 10′, remnants of the coconut may be left within the tubular member 42. The user may insert the rod member 52 into the tubular member 42. Remnants of the coconut left within the tubular member 42 may be pushed out the opening 46 formed in the tubular member 42.

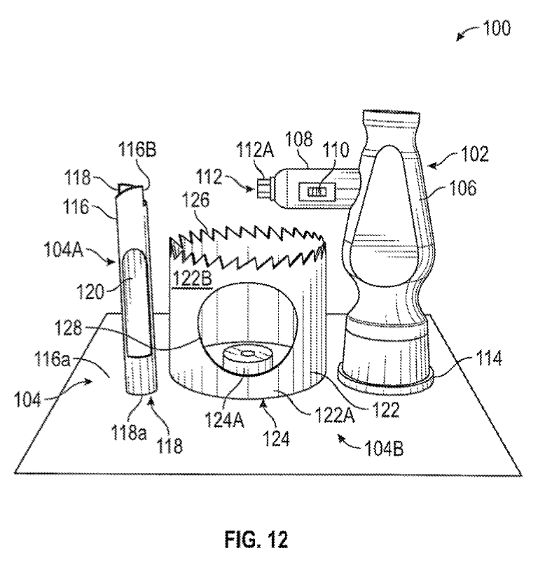

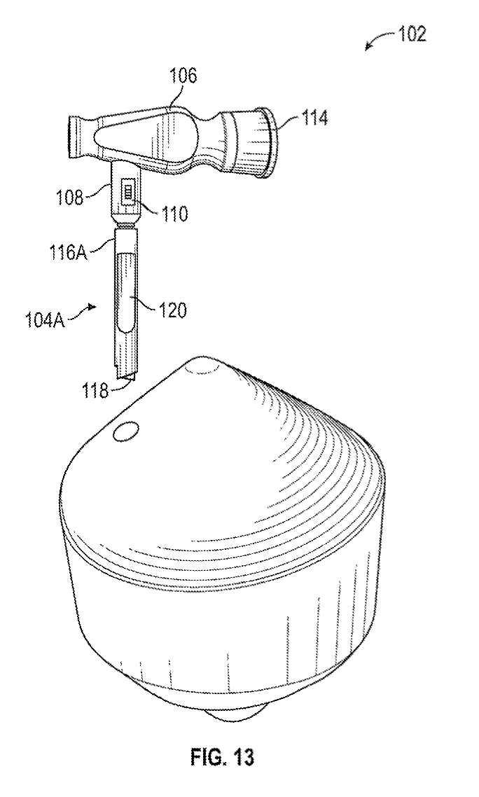

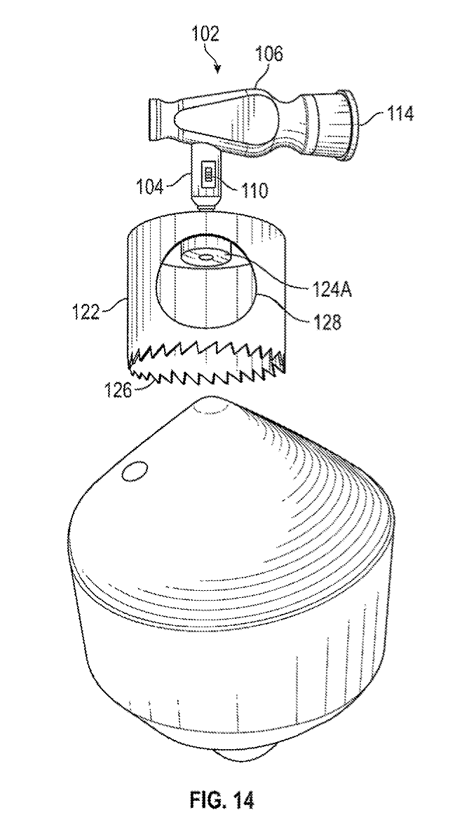

Referring to FIG. 12-14, an embodiment of a coconut water and meat removal device 100 (hereinafter device 100) is shown. The device 100 may be used to drain the coconut water formed inside the coconut and remove the meat from the coconut. The device 100 may have a drill unit 102. The drill unit 102 may be used to drive one or more attachments 104. The attachments 104 may be used to open the coconut to drain the coconut water as well as to cut the coconut to remove the coconut meat.

The drill unit 102 may have a motor 106. The motor 106 may be used to rotating a drive unit 108. A gear selector 110 may be coupled to the motor 106 and the drive unit 108. The gear selector 110 may be used to control the direction of rotation of the drive unit 108. For example, the gear selector 110 may be used to determine if the drive unit 108 rotates in a clockwise or counterclockwise direction.

Located on a distal end of the drive unit 108 may be a connector 112. The connector 112 may be used for coupling one or more attachments 104 to the drive unit 108. In accordance with one embodiment, the connector 112 may be a male connector 112A. The male connector 112A may connect with a female connector formed on the attachment 104 thereby securing the attachment 104 to the distal end of the drive unit 108.

A power supply 114 may be coupled to the motor 106. The power supply 114 may be used to power the drill unit 102. In accordance with one embodiment, the power supply may be a DC power supply such as a battery. Thereby allowing the drill unit 102 to be cordless. The battery may be a rechargeable battery.

The attachments 104 may be a draining attachment 104A. The draining attachment 104A may be used to drill a drainage hole into the coconut to allow one to drain the coconut water from the coconut. The draining attachment 104A may be formed of a tubular member 116. A first end 116A of the tubular member 116 may have a connector 118 formed thereon. In accordance with one embodiment, the connector 118 is a female connector 118A. The female connector 118A may connect with the male connector 112A of the drive unit 108 thereby securing the draining attachment 104A to the distal end of the drive unit 108.

A second end 116B of the tubular member 116 may have a jagged configuration. The second end 116B may have a plurality of teeth 118 extending down from the second end 116B. The teeth 118 may be curved to conform to the shape of the tubular member 116. The teeth 118 may allow the tubular member 116 to cut and penetrate into a coconut as described below.

The tubular member 116 may have an opening 120 formed therein to expose an interior of the tubular member 116. The opening 120 may have a rounded/curved bottom section. The opening 120 may run along a length of the tubular member 116. The opening 120 may be used to remove any debris and/or items that may be stuck in the interior of the tubular member 116 when the draining attachment 104A may be used to drill a drainage hole into the coconut. A rod member may be used that fits within the tubular member 116 to extract any debris and/or items that may be stuck in the interior of the tubular member 116.

One of the attachments 104 may be an opening attachment 104B. The opening attachment 104B may be used to drill a large hole into the coconut to allow one to access the coconut meat which is contained within the shell of the coconut. The opening attachment 104B may be formed of a cylindrical member 122. A first end 122A of the cylindrical member 122 may have a connector 124 formed thereon. In accordance with one embodiment, the connector 124 may be a female connector 124A. The female connector 124A may connect with the male connector 112A of the drive unit 108 thereby securing the opening attachment 104B to the distal end of the drive unit 108.

A second end 122B of the cylindrical member 122 may have a jagged configuration. The second end 122B may have a plurality of teeth 126 extending down from the second end 122B. The teeth 126 may be extend around the perimeter of the second end 122B of the cylindrical member 122. In accordance with one embodiment, the teeth 126 may have a saw-tooth configuration. The teeth 126 may allow the cylindrical member 116 to cut and penetrate into the coconut forming an opening in the coconut to access the coconut meat as described below.

The cylindrical member 122 may have an opening 128 formed on a side surface therein to expose an interior of the cylindrical member 122. The opening 128 may be used to remove any debris and/or items that may be stuck in the interior of the cylindrical member 122 when the opening attachment 104B may be used to drill a hole into the coconut.

While only one opening attachment 104B may be shown, the device 100 may have a plurality of different opening attachments 104B of differing sizes.

In operation, a user may drain the coconut water from the coconut. The user may attach the draining attachment 104A to the drill unit 102 to drill a drainage hole into the coconut to allow one to drain the coconut water from the coconut. The user may insert the female connector 118A of the draining attachment to the male connector 112A of the drive unit 108 thereby securing the draining attachment 104A to the distal end of the drive unit 108. The user may then press the second end 116B of the tubular member 116 so that the plurality of teeth 118 extending down from the second end 116B engages the coconut. The user may activate the drill unit 102 rotating the draining attachment 104A to cut and penetrate into the coconut to form a drainage hole. Once the drainage hole is formed, the user may then drain the coconut water from the coconut by tilting the coconut so that the drainage hole is facing downward.

After the coconut water has been drained, the user may form a larger opening in the coconut to remove the coconut meat from the interior of the coconut. To do this, the user may attach the opening attachment 104B to the drill unit 102 to drill the larger hole into the coconut to allow one to access the coconut meat contained in the interior of the shell of the coconut. The user may insert the female connector 124A into the male connector 112A of the drive unit 103 thereby securing the opening attachment 104B to the distal end of the drive unit 108. The user may then press the plurality of teeth 126 extending down from the second end 122B of the cylindrical member 122 into the coconut. The user may activate the drill unit 102 rotating the opening attachment 104B to cut and penetrate into the coconut to form the larger opening. Once the larger opening is formed, the user may then use a spoon or scoop to remove the coconut meat from the interior of the coconut water.

While embodiments of the disclosure have been described in terms of various specific embodiments, those skilled in the art will recognize that the embodiments of the disclosure may be practiced with modifications within the spirit and scope of the claims.

1-17. (canceled)

18. A device for removing coconut water and meat from a coconut comprising:
a drill unit; and
a plurality of attachments;
wherein a first attachment is removably coupled to the drill unit to drain the coconut water, the first attachment comprises:
a tubular member;
a connector formed on a first end of the tubular member;
a plurality of teeth extending down from a second end of the tubular member; and
an opening formed along a length of the hollow tubular member exposing an interior of the tubular member, the opening allowing removal of debris from the interior of the tubular member collected during drilling of the coconut.

19. The device of claim 18, wherein the connector of the first attachment is a female connector.

20. The device of claim 18, wherein a second attachment is removably coupled to the drill unit to open the coconut to remove the coconut meat when the first attachment is uncoupled from the drill unit.

21. The device of claim 18, wherein the second attachment comprises:
a cylindrical member;
a connector formed on a first end of the cylindrical member, and
a plurality of teeth extending down from a second end of the cylindrical member.

22. The device of claim 21, wherein the connector of the second attachment is a female connector.

23. The device of claim 21, wherein the cylindrical member has a window formed therein.

24. The device of claim 18, wherein the drill unit comprises:
a drive unit;
a motor to rotate the drive unit; and
a connector formed on a distal end of the drive unit.

25. The device of claim 24 wherein the drill unit comprises a power supply coupled to the motor.

26. The device of claim 24, wherein the drill unit comprises a gear selector coupled to the motor and the drive unit to control a direction of rotation of the drive unit.

26. A device for removing coconut water and meat from a coconut comprising:
a drill unit, wherein the drill unit comprises:
a drive unit;
a motor to rotate the drive unit; and
a connector formed on a distal end of the drive unit; and
a first attachment removably coupled to the drill unit to drain the coconut water, wherein the first attachment comprises:
a tubular member;
a connector formed on a first end of the tubular member; and
a plurality of teeth extending down from a second end of the tubular member; and
an opening formed along a length of the hollow tubular member exposing an interior of the tubular member, the opening allowing removal of debris from the interior of the tubular member collected during drilling of the coconut.

26. The device of claim 24, wherein a second attachment removably coupled to the drill unit to open the coconut to remove the coconut meat when the first attachment is uncoupled from the drill unit, wherein the second attachment comprises:
a cylindrical member;
a connector formed on a first end of the cylindrical member; and
a plurality of teeth extending down from a second end of the cylindrical member.

27. The device of claim 26, wherein the cylindrical member has a window formed therein.

28. The device of claim 26, wherein the drill unit comprises a power supply coupled to the motor.

29. The device of claim 26, wherein the drill unit comprises a gear selector coupled to the motor and the drive unit to control a direction of rotation of the drive unit.
